(19) United States
(12) Patent Application Publication
(10) Pub. No.: US 2010/0138414 A1
(43) Pub. Date: Jun. 3, 2010

(54) METHODS AND SYSTEMS FOR ASSOCIATIVE SEARCH

(76) Inventors: ANDREW NEWMAN, Franklin Lakes, NJ (US); Ron Franczyk, Kirkland, WA (US); Jim Heising, Redmond, WA (US); Kalid Azad, Seattle, WA (US)

Correspondence Address: Ballard Spahr LLP, SUITE 1000, 999 PEACHTREE STREET, ATLANTA, GA, 30309-3915, US

(21) Appl. No.: 12/325,429

(22) Filed: Dec. 1, 2008

(51) Int. Cl. G06F 17/30; G06F 7/00

(52) U.S. Cl. 707/735; 707/E17.014; 707/E17.044

(57) ABSTRACT

Provided are methods and systems for associative search to find an entity (for example, people, places, things, events, ideas and concepts) based on their association (affinity) to other entities.

### SUMMARY

In an aspect, provided are methods and systems for affinity searching, comprising determining a data source, extracting a plurality of entities from the data source, wherein the plurality of entities comprises a first entity and a second entity, extracting one or more relationships between the plurality of entities from the data source, storing each of the one or more relationships between the plurality of entities as a vector, wherein each relationship is represented by one vector, creating a graph by linking the plurality of entities to each vector that represents a relationship of the entity linked, and calculating an affinity between at least the first entity and the second entity based on the graph.

In another aspect, provided are methods and systems for affinity searching, comprising receiving a query and applying the query to an affinity database, wherein the affinity database was created by, determining a data source, extracting a plurality of entities from the data source, wherein the plurality of entities comprises a first entity and a second entity, extracting one or more relationships between the plurality of entities from the data source, storing each of the one or more relationships between the plurality of entities as a vector, wherein each relationship is represented by one vector, creating a graph by linking the plurality of entities to each vector that represents a relationship of the entity linked, and calculating an affinity between at least the first entity and the second entity based on the graph.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is an exemplary operating environment;

FIG. 2 illustrates an exemplary graph with entities as nodes and edges as relationships between the entities;

FIG. 3 is an exemplary graph illustrating relationships between restaurants;

FIG. 4 is an exemplary method for associative searching;

FIG. 5 illustrates entities related by various data sources;

FIG. 6 illustrates entities linked to multiple parent vectors;

FIG. 7 is an example of filtering results based on affinity;

FIG. 8 illustrates clustering entities based on mutual affinity;

FIG. 9 is an exemplary method for affinity searching; and

FIG. 10 is another exemplary methods for affinity searching.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

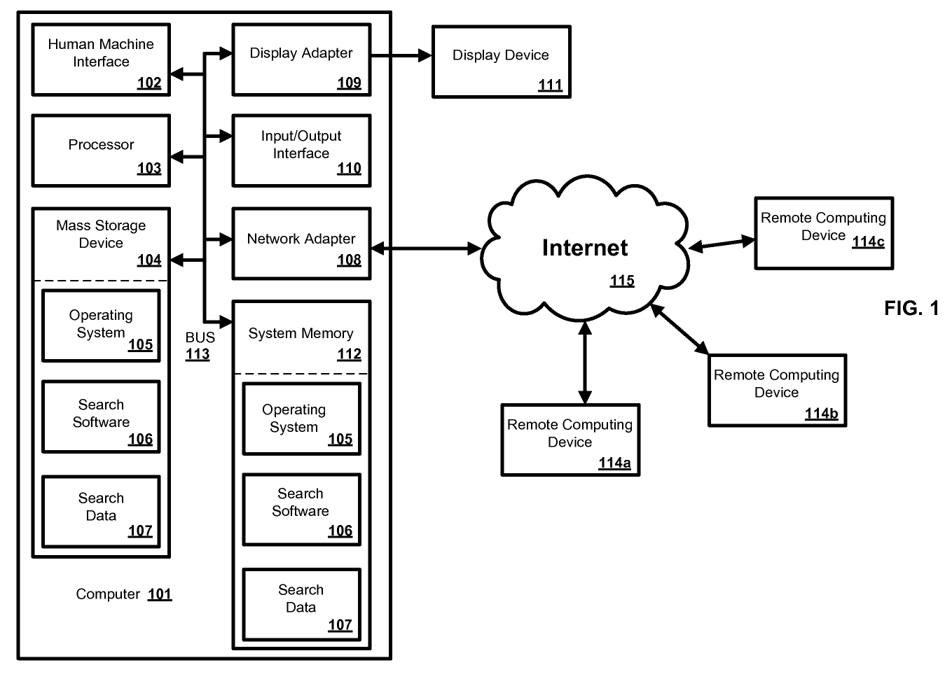

FIG. 1 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the system and method comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed system and method can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed method can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the system and method disclosed herein can be implemented via a general-purpose computing device in the form of a computer 101. The components of the computer 101 can comprise, but are not limited to, one or more processors or processing units 103, a system memory 112, and a system bus 113 that couples various system components including the processor 103 to the system memory 112. In the case of multiple processing units 103, the system can utilize parallel computing.

The system bus 113 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 113, and all buses specified in this description can also be implemented over a wired or wireless network connection and each of the subsystems, including the processor 103, a mass storage device 104, an operating system 105, search software 106, search data 107, a network adapter 108, system memory 112, an Input/Output Interface 110, a display adapter 109, a display device 111, and a human machine interface 102, can be contained within one or more remote computing devices 114a,b,c at physically separate locations, connected through buses of this form, in effect implementing a fully distributed system.

The computer 101 typically comprises a variety of computer readable media. Exemplary readable media can be any available media that is accessible by the computer 101 and comprises, for example and not meant to be limiting, both volatile and non-volatile media, removable and non-removable media. The system memory 112 comprises computer readable media in the form of volatile memory, such as random access memory (RAM), and/or non-volatile memory, such as read only memory (ROM). The system memory 112 typically contains data such as search data 107 and/or program modules such as operating system 105 and search software 106 that are immediately accessible to and/or are presently operated on by the processing unit 103.

In another aspect, the computer 101 can also comprise other removable/non-removable, volatile/non-volatile computer storage media. By way of example, FIG. 1 illustrates a mass storage device 104 which can provide non-volatile storage of computer code, computer readable instructions, data structures, program modules, and other data for the computer 101. For example and not meant to be limiting, a mass storage device 104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 104, including by way of example, an operating system 105 and search software 106. Each of the operating system 105 and search software 106 (or some combination thereof) can comprise elements of the programming and the search software 106. Search data 107 can also be stored on the mass storage device 104. Search data 107 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 101 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 103 via a human machine interface 102 that is coupled to the system bus 113, but can be connected by other interface and bus structures, such as a parallel port, game port, an IEEE 1394 Port (also known as a Firewire port), a serial port, or a universal serial bus (USB).

In yet another aspect, a display device 111 can also be connected to the system bus 113 via an interface, such as a display adapter 109. It is contemplated that the computer 101 can have more than one display adapter 109 and the computer 101 can have more than one display device 111. For example, a display device can be a monitor, an LCD (Liquid Crystal Display), or a projector. In addition to the display device 111, other output peripheral devices can comprise components such as speakers (not shown) and a printer (not shown) which can be connected to the computer 101 via Input/Output Interface 110. Any step and/or result of the methods can be output in any form to an output device. Such output can be any form of visual representation, including, but not limited to, textual, graphical, animation, audio, tactile, and the like.

The computer 101 can operate in a networked environment using logical connections to one or more remote computing devices 114a,b,c. By way of example, a remote computing device can be a personal computer, portable computer, a server, a router, a network computer, a peer device or other common network node, and so on. Logical connections between the computer 101 and a remote computing device 114a,b,c can be made via a local area network (LAN) and a general wide area network (WAN). Such network connections can be through a network adapter 108. A network adapter 108 can be implemented in both wired and wireless environments. Such networking environments are conventional and commonplace in offices, enterprise-wide computer networks, intranets, and the Internet 115.

For purposes of illustration, application programs and other executable program components such as the operating system 105 are illustrated herein as discrete blocks, although it is recognized that such programs and components reside at various times in different storage components of the computing device 101, and are executed by the data processor(s) of the computer. An implementation of search software 106 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any method or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

In an aspect, provided are methods and systems for a type of associative search that can be used, for example, to find people, places, things, events, ideas and concepts (collectively, “entities”) based on their association (affinity) to other entities.

The methods and systems provided can allow a user to browse for results using specific entities that capture the spirit of the desired results (“Mercedes Benz®”) without having to revert to a keyword-based description (“high-end luxury goods”).

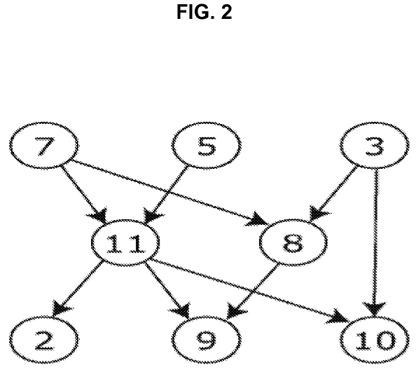

An embodiment of the invention comprises a graph theoretic approach to generate a hierarchy of entities (searchable items) and the weights between them. FIG. 2 illustrates an exemplary graph with entities as nodes and edges as relationships between the entities. The weights between entities can be determined by how the entities appear in similar contexts, and entities with a stronger weight are related more closely. As used herein, an entity can refer to persons, places, concepts, goods, services, ideas, or any semantic element which can be represented in data. In an aspect, weighting can mean that entities one node away from each other are most related, entities two nodes away from each other are 50% as important, entities 3 nodes away from each other are 25% related, etc. (the exact values of importance can be varied, as is known to one of skill in the art). An affinity score for an entity can be determined by summing the weights to the entity. For example, Entity A=>Entity B may have an affinity score of “1” because Entity A is one node away from Entity B, whereas Entity A=>Entity C has a score of 0.5 because Entity A is two nodes away from Entity C. To determine a “high” affinity score, both an absolute and a relative ranking can be used. One of skill in the art can determine what a strong relationship is between entities based on the data used. For example, a high affinity score can be 0.5 or higher. A percentile rank can be used, for example, if a segment of data is weakly connected (several nodes between entities) then a score of 0.25 can be in the top percentile of relationships, and thus the highest score (in that weak set).

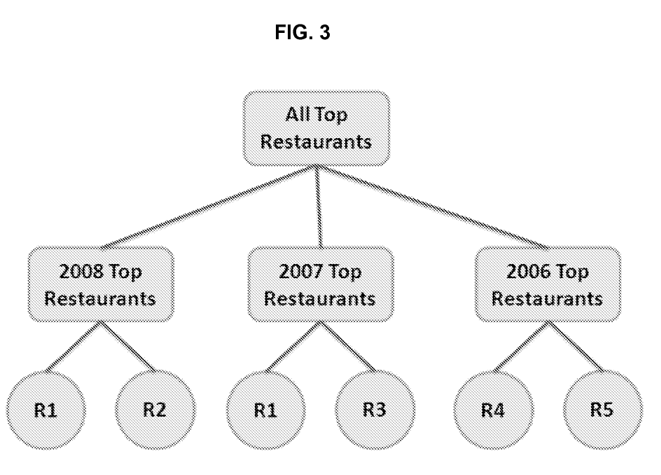

By way of example, a “top 10” list rates the best restaurants each year. In 2008 the top 10 list contained restaurants R1 and R2, in 2007 the top 10 list contained R1 and R3, and in 2006 the top 10 list contained R4 and R5 (see FIG. 3). Each restaurant in the same year is connected because they are part of the same relationship vector (“2008 Top Restaurant”, for example). All the winners are connected at a higher level (“Top Restaurant”) but restaurants in the same year have the highest connection. Graph theory, such as searching algorithms as known in the art, can be used to find the minimum distance (number of steps) between entities. At a high level, relationships (2008 award winners) can be viewed as special instances of higher-level relationships (all award-winning restaurants).

The entities can be automatically categorized into groups, based on an affinity or similarity measure between entities (entities with a higher affinity score are more closely related). Affinity can be a measure of the relatedness between two or more entities. For example, Mercedes Benz®, Grey Goose Vodka® and Rolex® can be automatically categorized into the same group because they appear in similar contexts, even though may not appear on a specific text-based list. In addition, the categorizing traits do not need to be explicitly labeled or described (“high end luxury goods”).

The methods and systems provided can search and filter results, so that a certain category of entities (cars) can be tilted towards one entity (Baseball Game) or another (Theater). Each choice implies different, intangible qualities in the desired result.

The methods and systems provided, while referred to as searching methods and systems, can be viewed as exploration tools. The methods and systems allow for searching without keywords. Current search engines require you to know what you are looking for and formulate a query with text-based keywords. It is often difficult or impossible to find entities similar to what you already know, for example a hotel in California “like” the one you enjoyed in your hometown (or a car embodying the same spirit as the hotel you enjoyed in your hometown).

The methods and systems provided have a broad search scope. Current product recommendation databases, such as Amazon®, Netflix®, and Like.com, constrain suggestions to entities within their own product lines. The methods and systems provided can allow for browsing of similar entities between any category, not simply products sold or offered from a single source.

The methods and systems can utilize automatic “virtual” classification. Entities can be grouped into classes without requiring a specific, tangible keyword to link them. For example, cars “like” Ferrari® can be grouped together based on their affinity, without the need for each car to be explicitly described as a “luxury vehicle.” Any entity can be used as a “category seed” to find related entities, without the need for specific keywords.

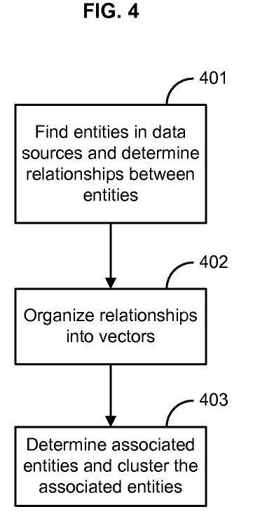

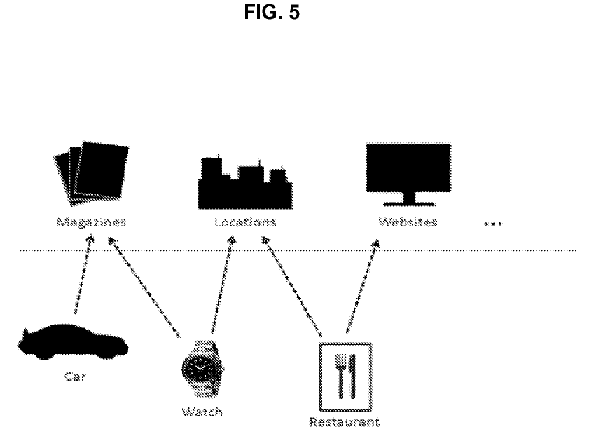

In an aspect, illustrated in FIG. 4, provided are methods for associative searching. At block, 401, entities can be found in data sources and relationships between entities can be determined. Data sources can include, but are not limited to, digital file, a digital image, a digital video file, a digital audio file, a text file, a hypertext document, a print document, a print image, analog audio, and analog video. Examples of data sources include, but are not limited to, newspapers, magazines, websites, product databases, lists based on user preference or behavior, almanacs and compendiums, award lists and other forms of recognition. This can involve, for example, finding data sources containing relationships between entities (such as web pages, magazines, maps, brochures, books, etc.). FIG. 5 shows an example of entities related by various data sources. Entities referenced in the data sources can be extracted and stored. In an aspect, this can be performed using natural-language processing, analyzing the text of hyperlinks, analyzing the text of page titles, traditional crawling methods as known in the art, and the like. In an aspect, entities can have an additional “category” tag (such as Hotels, Restaurants, or a type of Product). Relationships between entities can be extracted from the data sources. A relationship represents a connection between two entities, often as simplified to a subject-verb-object structure (where the “verb” represents the relationship). Examples of relationships include, but are not limited to, appears with, wrote about, was rated five stars by, was born in, and the like.

At block 402, the relationships can be organized into vectors. A vector is a data structure that contains a relationship, and all elements that share that relationship. In an aspect, a vector can be a list that comprises elements that have a common property (the relationship).

For example, Vector 1 (“Entities appearing in Magazine XYZ”) can link Entities A, B and C—the common link being that they all appeared in Magazine XYZ. Vector 2 (“Things rated 5 stars by User X”) can link Entities D, E and F. Vector 3 (“People born in 1965”) can link Entities A, B and D. Vectors can be organized into hierarchies, so the vector, “Items in June 2008 Issue of Magazine XYZ” can be a child of “Items in Magazine XYZ” which can be a child of “Magazines”, which can be a child of “Print Media,” and the like.

The strength of the relationship may be weighted. That is, certain vectors may impact the final affinity score differently based on the relationship they describe. A vector for “Rated 5 stars by a user” may link entities more strongly than the vector “Casually mentioned by a user”.

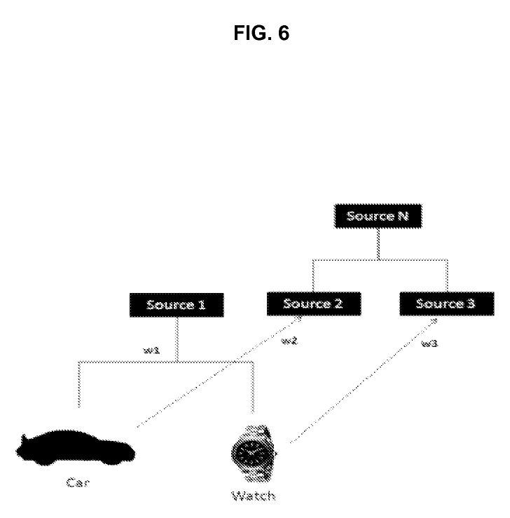

In an aspect, a unique entity can be linked to a parent vector using a tree (Directed Acyclic Graph). FIG. 6, shows an example of entities being linked to multiple parent vectors.

The distance in the graphs can be determined to find an affinity between entities. This is similar to finding how close two relatives are connected. For example, to find the connection from Entity A to Entity B, one could examine the vectors and see if they had any in common (for example, “Items in June 2008 Issue of Magazine XYZ”). Because Entity A and Entity B share a common parent vector, they are “siblings”. Another item, Entity C, could have appeared in a different issue of the magazine—to find the distance, we could traverse the graph (one step at a time) to find the common ancestor: “Items in Magazine XYZ”. In this case A and C would be “cousins”, since they appeared in the same magazine but in different issues. This distance computation can be single dimensional or multi-dimensional, depending on the number of paths traversed (entities can have several unrelated ancestors so there can be several paths to follow). In addition, the number of nodes traversed in the graph from one entity to another entity can be determined and modified by the weight of each vector. The more parent vectors two entities share, the higher their affinity.

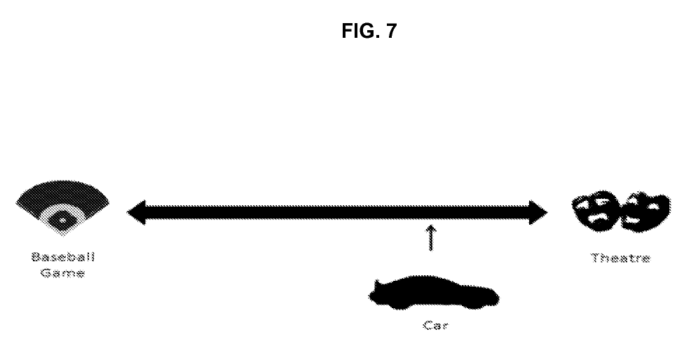

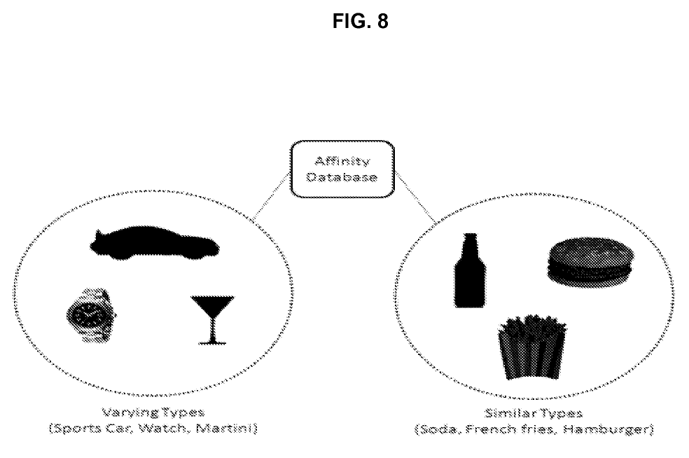

At block 403, associated entities can be determined and clustered. When a users browses for entities similar to entity A, a search can be performed across all entities to find their affinity to entity A (for efficiency, this can be stored in a pre-computed lookup table). A user can also search with multiple entities. The results can then be filtered, and the highest-rated entities displayed to the user. FIG. 7 shows an example of filtering results based on affinity to one entity or another. Entities can then be clustered. Entities can be grouped into virtual categories using the constructed tree as a data source for collaborative filtering techniques. Any clustering schemes can be used, for example, KNN (K-nearest neighbor), PCA, and the like, which can reduce multi-dimensional data into virtual groups. No specific keyword attribute is required to create these groups. FIG. 8 shows an example of clustering entities based on mutual affinity (a group of entities having a high affinity score for each other).

By way of example, a user is not required search for the text “romantic items” to describe what they want. A search can be performed for a specific entity, like the book “Romeo and Juliet.” That search can retrieve the specific entity in the database, and similar entities, based on their affinity to the book, can be returned. These results can be other books, music, restaurants, hotels or anything that may have some affinity to the original entity. There is no requirement for a specific string match between “Romeo and Juliet,” “romance,” and the returned results.

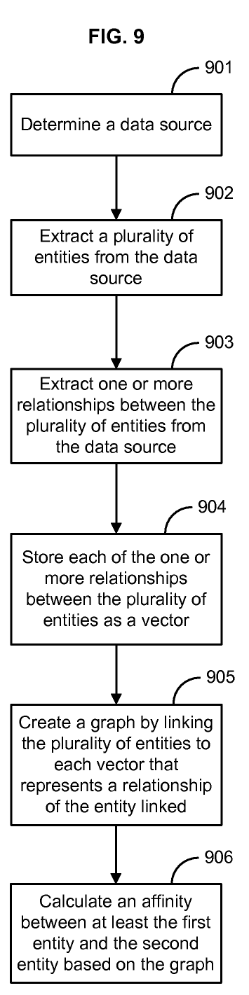

In another aspect, illustrated in FIG. 9, provided are methods for affinity searching, comprising determining a data source at 901, extracting a plurality of entities from the data source at 902, wherein the plurality of entities comprises a first entity and a second entity, extracting one or more relationships between the plurality of entities from the data source at 903, storing each of the one or more relationships between the plurality of entities as a vector at 904, wherein each relationship is represented by one vector, creating a graph by linking the plurality of entities to each vector that represents a relationship of the entity linked at 905, and calculating an affinity between at least the first entity and the second entity based on the graph at 906.

Calculating an affinity between the first entity and the second entity based on the graph can comprise determining a number of entities and/or vectors between the first entity and the second entity. The methods can further comprise assigning a relationship weight to the one or more relationships. Calculating an affinity between the first entity and the second entity based on the graph can comprise determining a number of vectors that represents a relationship of both the first entity and the second entity. The methods can further comprise storing the affinity in a lookup table. The methods can further comprise determining a similarity between the first entity and the second entity based on the affinity.

The methods can further comprise grouping one or more entities that are similar to the first entity into a virtual category. Grouping one or more entities that are similar to the first entity into a virtual category can comprise determining affinities between the first entity and the one or more entities. Grouping one or more entities that are similar to the first entity into a virtual category can comprise applying a clustering algorithm.

The plurality of entities can be at least two of a product, a product category, a brand, a trademark, a service, a service category, a service mark, and the like. A data source can comprise at least one of a digital file, a digital image, a digital video file, a digital audio file, a text file, a hypertext document, a print document, a print image, analog audio, analog video, and the like. The plurality of entities can be extracted from the data source by applying at least one of natural language processing, text processing, hyperlink processing, and the like. The methods can further comprise updating the graph with a new data source.

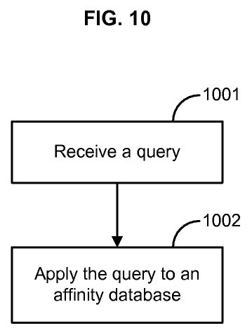

In another aspect, illustrated in FIG. 10, provided are methods for affinity searching, comprising receiving a query at 1001 and applying the query to an affinity database at 1002, wherein the affinity database was created by, determining a data source, extracting a plurality of entities from the data source, wherein the plurality of entities comprises a first entity and a second entity, extracting one or more relationships between the plurality of entities from the data source, storing each of the one or more relationships between the plurality of entities as a vector, wherein each relationship is represented by one vector, creating a graph by linking the plurality of entities to each vector that represents a relationship of the entity linked, and calculating an affinity between at least the first entity and the second entity based on the graph.

Receiving a query can comprise receiving a query in the form of an entity. Receiving a query can comprise receiving a query in the form of a category. Receiving a query can comprise receiving a query in the form of an entity similar to another entity. Receiving a query can comprise receiving a query in the form of an entity similar to a category. Receiving a query can comprise receiving a request to browse for entities by category.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method for affinity searching, comprising:
determining a data source;
extracting a plurality of entities from the data source, wherein the plurality of entities comprises a first entity and a second entity;
extracting one or more relationships between the plurality of entities from the data source;
storing each of the one or more relationships between the plurality of entities as a vector, wherein each relationship is represented by one vector;
creating a graph by linking the plurality of entities to each vector that represents a relationship of the entity linked; and
calculating an affinity between at least the first entity and the second entity based on the graph.

2. The method of claim 1, wherein calculating an affinity between the first entity and the second entity based on the graph comprises determining a number of entities and/or vectors between the first entity and the second entity.

3. The method of claim 1, further comprising assigning a relationship weight to the one or more relationships.

4. The method of claim 1, wherein calculating an affinity between the first entity and the second entity based on the graph comprises determining a number of vectors that represents a relationship of both the first entity and the second entity.

5. The method of claim 1, further comprising storing the affinity in a lookup table.

6. The method of claim 1, further comprising determining a similarity between the first entity and the second entity based on the affinity.

7. The method of claim 1, further comprising grouping one or more entities that are similar to the first entity into a virtual category.

8. The method of claim 7, wherein grouping one or more entities that are similar to the first entity into a virtual category comprises determining affinities between the first entity and the one or more entities.

9. The method of claim 8, wherein grouping one or more entities that are similar to the first entity into a virtual category comprises applying a clustering algorithm.

10. The method of claim 1, wherein the plurality of entities is at least two of a product, a product category, a brand, a trademark, a service, a service category, a service mark.

11. The method of claim 1, wherein a data source comprises at least one of a digital file, a digital image, a digital video file, a digital audio file, a text file, a hypertext document, a print document, a print image, analog audio, and analog video.

12. The method of claim 1, wherein the plurality of entities are extracted from the data source by applying at least one of natural language processing, text processing, or hyperlink processing.

13. The method of claim 1, further comprising updating the graph with a new data source.

14. A method for affinity searching, comprising:
receiving a query; and
applying the query to an affinity database, wherein the affinity database was created by,
determining a data source,
extracting a plurality of entities from the data source, wherein the plurality of entities comprises a first entity and a second entity,
extracting one or more relationships between the plurality of entities from the data source,
storing each of the one or more relationships between the plurality of entities as a vector, wherein each relationship is represented by one vector,
creating a graph by linking the plurality of entities to each vector that represents a relationship of the entity linked, and
calculating an affinity between at least the first entity and the second entity based on the graph.

15. The method of claim 14, wherein receiving a query comprises receiving a query in the form of an entity.

16. The method of claim 14, wherein receiving a query comprises receiving a query in the form of a category.

17. The method of claim 14, wherein receiving a query comprises receiving a query in the form of an entity similar to another entity.

18. The method of claim 14, wherein receiving a query comprises receiving a query in the form of an entity similar to a category.

19. The method of claim 14, wherein receiving a query comprises receiving a request to browse for entities by category.
